(19) United States
(12) Patent Application Publication
(10) Pub. No.: US 2016/0171520 A1
(43) Pub. Date: Jun. 16, 2016

(54) METHOD AND SYSTEM FOR MONITORING AND REWARDING THE CONSUMPTION OF STREAMING MEDIA

(71) Applicant: Autography LLC, St. Petersburg, FL (US)

(72) Inventors: Thomas J. Waters, St. Petersburg, FL (US); Robert N. Barrett, St. Petersburg, FL (US)

(21) Appl. No.: 14/970,938

(22) Filed: Dec. 16, 2015

Related U.S. Application Data
(60) Provisional application No. 62/092,630, filed on Dec. 16, 2014.

(51) Int. Cl. G06Q 30/02; G06Q 30/00; H04L 29/06

(52) U.S. Cl. CPC G06Q 30/0224; H04L 65/4069; G06Q 30/0185

(57) ABSTRACT

Disclosed are systems and methods for rewarding streaming media consumption of a media consumer with a redeemable electronic reward.

### CROSS-REFERENCE TO RELATED APPLICATION

This application claims priority to U.S. Provisional Patent Application No. 62/092,630 filed on Dec. 16, 2014, the contents of which are incorporated by reference herein.

### TECHNICAL FIELD

The present invention relates generally to the field of streaming media consumption, and more particularly, to monitoring streaming media consumption of a media consumer and providing incentives/rewards to the media consumer based on streaming media consumption.

### BACKGROUND

According to Billboard Magazine, digital download sales were down by 2.1% last year while streaming media consumption increased by more than 51%. Thus, as indicated by the above statistics, streaming technology has made significant inroads into numerous areas of digital delivery, prompting certain businesses to focus almost exclusively on delivering entertainment via this method. For example, businesses specializing in streaming media include, but are not limited to:
Ebooks: Scribd, Oyster
Music: Spotify, Pandora
Movies: Netflix, Roku
Television: Hulu, Xfinity
Video games: Twitch, Ubitus

Dramatically increased streaming media consumption coupled with losses in digital download sales have fragmented the entertainment industry, forcing legacy media firms to adapt new business models. For example, historically, purchased physical discs (CD's) and digital downloads (iTunes) have been the defacto means for determining top sellers of specific music genres. Similarly, theater ticket sales and purchased video downloads are compiled to determine the highest grossing movies. However, with the emergence of streaming media, these metrics are no longer relevant.

As alluded to above, consumers are buying less, for CDs and digital downloads, and are beginning to stream more and more digital content. In these aspects, the streaming media purchased by a consumer is not permanently purchased and/or stored on a media device. Instead, a fee is paid for temporary access to the media stream. As a result, it is important for artists to quickly identify emerging and committed fans to potentially bolster streaming revenues. Once identified, artists can incentivize these fans through concert appearances and merchandizing opportunities (e.g., t-shirts, posters, etc.).

Artists need data to make this possible. With the prior ownership/download model (i.e., buying CDs and/or purchasing digital downloads) artists had no accurate way of knowing how many times a fan listened to a song or watched a film.

### BRIEF SUMMARY

Disclosed are new and innovative systems and methods for rewarding individual consumers of digital media (television, games, music, radio, movies, live events and other forms of broadcast or recorded entertainment) in a manner that would promote loyalty to and/or improve recognition of certain content, while providing information and marketing opportunities to the entire audience or at an individualized level for content providers and advertisers. By utilizing these systems and methods, media providers (e.g., artists) can accurately ascertain when their work has been discovered by a new fan, which consumers are repeatedly enjoying the artist's work, and which fans may require incentive(s) to maintain media consumption.

Disclosed is a method for rewarding streaming media consumption of a media consumer with a redeemable electronic reward, the method including: (a) providing a database for storing a user account associated with the media consumer; (b) accessing a user identification engine that obtains information from the media consumer, the user identification engine configured for populating the user account of the media consumer with streamed media of the media consumer; (c) monitoring and capturing information related to the amount of streamed media of the media consumer in a predetermined period of time (e.g., weekly, monthly, etc.) with a data capture program that is in operable communication with the user identification engine relating to the streamed media of the media consumer; (d) analyzing the captured information related to the streamed media of the media consumer to determine if a predetermined threshold of streamed media has been reached by the media consumer; (e) confirming that the predetermined threshold of step (d) has been reached by the media consumer; and (f) rewarding the media consumer with the redeemable electronic reward after step (e) based on the media consumer reaching the predetermined threshold of media consumption by electronically communicating the redeemable electronic reward to the media consumer, wherein: the redeemable electronic reward comprises at least one of a gift card, digital memorabilia, or a combination thereof. In certain aspects, the disclosed method can be utilized for one device (e.g., a peripheral device, gaming console, device dedicated solely for streaming, etc.) or can be utilized by a plurality of these devices. In certain aspects, the redeemable electronic reward may be tied to viewing consumption for one specific device, or in other aspects, the redeemable electronic reward may be tied to aggregated data from viewing consumption of a plurality of devices utilizing the disclosed methods and systems. In certain aspects, the methods and systems can apply to partially viewed and/or completely viewed (and/or listened to) streamed content by the media consumer.

In certain aspects, the methods and systems utilize a peripheral device (e.g., a smartphone, a laptop, a tablet, etc.) of the media consumer and the electronic redeemable reward is communicated to the peripheral device of the media consumer. In certain aspects, the method consists of sequential steps (a)-(f). In addition to peripheral devices, it is envisioned that the disclosed methods and systems can further utilize gaming consoles including, but not limited to, an Xbox or PlayStation and/or other devices dedicated for streaming (e.g., Roku 3, Apple TV, Amazon Firestick, Smart TVs, etc.).

In certain aspects, the method further includes associating the streamed media by the media consumer with a single streamed media provider, the streamed media provider can include a celebrity, an athlete, a musician, or a combination thereof.

In certain aspects, the media provider rewards the media consumer with digital memorabilia. The digital memorabilia can include an electronic autograph, an electronic written message, an electronic video message, only an electronic audio message, or a combination thereof.

In certain aspects, the digital memorabilia includes at least two of the following: (i) an electronic autograph, (ii) an electronic written message, (iii) an electronic video message, (iv) only electronic audio message, or (v) a combination thereof.

In certain aspects, the digital memorabilia further includes a certificate of authenticity verifying authenticity of the digital memorabilia. For example, the certificate of authentication may be generated by a scoring number associated with a media provider's signature (and/or writing samples), voice recognition, facial recognition, or a combination thereof. The media provider's autograph or electronic written message, for example, must achieve at least a 90% confidence level based on an X,Y array coordinates including a statistical comparison of velocity between coordinates and relative position of points between coordinates and the voice message, video message, or combination thereof, if present, must achieve at least a 90% confidence level based on amplitude and frequency and/or facial recognition when compared to reference samples of the media provider. Facial recognition can be calculated using a two dimensional mapping matrix comparing X,Y array coordinates of the media provider and comparing these values to a control, reference sample. In other aspects, the media provider's electronic signature or the electronic written message must achieve at least a 95% confidence level based on an X,Y array coordinates including a statistical comparison of velocity between coordinates and relative position of points between coordinates and the voice message, video message, or combination thereof, if present, must achieve at least a 95% confidence level based on amplitude and frequency and/or facial recognition when compared to reference samples of the media provider. In additional aspects, the electronic signature and the electronic written message must achieve at least a 99% confidence level based on an X,Y array coordinates including a statistical comparison of velocity between coordinates and relative position of points between coordinates and wherein at least one of the voice message, the video message, or a combination thereof and must achieve at least a 99% confidence level based on amplitude and frequency and/or facial recognition when compared to reference samples of the media provider.

Also disclosed is a non-transitory computer readable medium embodying a program executable in a computing device (e.g., a smartphone, laptop, tablet, etc.) for rewarding streaming media consumption of a media consumer with a redeemable electronic reward, the method including: (a) providing a database for storing a user account associated with the media consumer; (b) accessing a user identification engine that obtains information from the media consumer, the user identification engine configured for populating the user account of the media consumer with streamed media of the media consumer; (c) monitoring and capturing information related to the amount of streamed media of the media consumer in a predetermined period of time with a data capture program that is in operable communication with the user identification engine relating to the streamed media of the media consumer; (d) analyzing the captured information related to the streamed media of the media consumer to determine if a predetermined threshold of streamed media has been reached by the media consumer; (e) confirming that the predetermined threshold of step (d) has been reached by the media consumer; and (f) rewarding the media consumer with the redeemable electronic reward after step (e) based on the media consumer reaching the predetermined threshold of media consumption by electronically communicating the redeemable electronic reward to the media consumer, wherein: the redeemable electronic reward includes at least one of a gift card, digital memorabilia, or a combination thereof. In certain aspects, the non-transitory computer readable medium consists of sequential steps (a)-(f).

One embodiment of the invention allows artists (media providers) to identify when a consumer listened to a streamed song the first time as evidenced by the consumer hitting the ‘replay’ or ‘rewind’ button on their media device to hear the song again. Such an action identifies new media consumers for a specific media provider and such an action can be rewarded by the artist if desired.

In another embodiment, the artist can be notified that fan (media consumer) has repeatedly listened to work associated with that artist over a given period of time. In this instance, the artist could send the fan a signed photo or a discount e-gift card for more music or tour merchandizing materials.

In another embodiment, the artist can identify, using the disclosed systems and methods, a long term fan in a city where the artist has an upcoming live concert event. The artist can send the fan two free back stage passes as the redeemable electronic reward so the artist and fan can meet in person.

In another embodiment, artists can track how their music moves across fan's playlists, giving them additional insight into fan sociocultural demographics. Knowing which songs appeal to specific fans gives artists additional information about what their fans want in the future.

Embodiments of the invention can include one or more or any combination of the above features and configurations.

Additional features, aspects and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

These and other features, aspects and advantages of the present invention are better understood when the following detailed description of the invention is read with reference to the accompanying drawings, in which:

FIG. 1 depicts an exemplary current method for purchasing and/or downloading digital media (music, movies, tv, video games) from an online retailer;

FIG. 2 depicts an exemplary method for streaming media to a peripheral device;

FIG. 3 depicts an exemplary method for monitoring streamed media by a media consumer; and

FIG. 4 depicts rewarding the media consumer with a redeemable electronic reward based on meeting a predetermined threshold for streaming media consumption.

### DETAILED DESCRIPTION

The present invention will now be described more fully hereinafter with reference to the accompanying drawings in which exemplary embodiments of the invention are shown. In particular, the present invention is described below with reference to block diagrams and operational illustrations of methods, systems, and devices to select and present media related to a specific topic. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. Furthermore, the embodiments of methods presented are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently. The invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings.

Generally, in terms of hardware architecture for the electronic devices disclosed below, computing device includes a processor, a memory, and one or more input and/or output (I/O) devices (or peripherals) that are communicatively coupled via a local interface. Local interface may be one or more buses or other wired or wireless connections, as is known in the art. Local interface may have additional elements, which are omitted for simplicity, such as controllers, buffers (caches), drivers, transmitters, and receivers to facilitate external communications with other like or dissimilar computing devices. Further, local interface may include address, control, and/or data connections to enable internal communications among the other computer components.

The processor is a hardware device for executing software, particularly software stored in memory. The processor can be any custom made or commercially available processor, such as, for example, a Core series or vPro processor made by Intel Corporation, or a Phenom, Athlon or Sempron processor made by Advanced Micro Devices, Inc. In the case where computing device is a server, the processor may be, for example, a Xeon or Itanium processor from Intel, or an Opteron-series processor from Advanced Micro Devices, Inc. Processor may also represent multiple parallel or distributed processors working in unison. Processor may also represent multiple processors located in a plurality of computing devices working in parallel, unison, or serial effort to achieve the disclosed methods.

Memory can include any one or a combination of volatile memory elements (e.g., random access memory (RAM, such as DRAM, SRAM, SDRAM, etc.)) and nonvolatile memory elements (e.g., ROM, hard drive, flash drive, CDROM, etc.). It may incorporate electronic magnetic, optical, and/or other types of storage media. Memory can have a distributed architecture where various components are situated remote from one another, but are still accessed by processor. These other components may reside on devices located elsewhere on a network or in a cloud arrangement.

The software in memory may include one or more separate programs. The separate programs comprise ordered listings of executable instructions for implementing logical functions. The software in memory may include the system in accordance with the invention, and a suitable operating system (O/S). Examples of suitable commercially available operating systems are Windows operating systems available from Microsoft Corporation, Mac OS X available from Apple Computer, Inc., a Unix operating system from AT&T, or a Unix-derivative such as BSD or Linux. The operating system O/S will depend on the type of computing device. For example, if the computing device is a PDA or handheld computer (e.g., smartphone), the operating system may be iOS for operating certain devices from Apple Computer, Inc., PalmOS for devices from Palm Computing, Inc., Windows Phone 8 from Microsoft Corporation, Android from Google, Inc., or Symbian from Nokia Corporation. Operating system essentially controls the execution of other computer programs, such as the system, and provides scheduling, input-output control, file and data management, memory management, and communication control and related services.

If computing device is a PC compatible computer, Apple® computer, a handheld device, or the like, the software in memory may further include a basic input output system (BIOS). The BIOS is a set of essential software routines that initialize and test hardware at startup, start operating system, and support the transfer of data among the hardware devices. The BIOS is stored in ROM so that the BIOS can be executed when computing device is activated.

Steps and/or elements, and/or portions thereof of the invention may be implemented using a source program, executable program (object code), script, or any other entity comprising a set of instructions to be performed. Furthermore, the software embodying the invention can be written as (a) an object oriented programming language, which has classes of data and methods, or (b) a procedural programming language, which has routines, subroutines, and/or functions, for example but not limited to, C, C++, C#, Pascal, Basic, Fortran, Cobol, Perl, Java, Ada, Python, Swift, and Lua.

I/O device may include input devices such as a keyboard, a mouse, a scanner, a microphone, a touch screen, a bar code reader, or an infra-red reader. It may also include output devices such as a printer, a video display, an audio speaker or headphone port or a projector. I/O device may also comprise devices that communicate with inputs or outputs, such as a short-range transceiver (RFID, Bluetooth, etc.), a telephonic interface, a cellular communication port, a router, or other types of network communication equipment. I/O device may be internal to computing device, or may be external and connected wirelessly or via connection cable, such as through a universal serial bus port.

When the computing device is in operation, processor is configured to execute software stored within memory, to communicate data to and from memory, and to generally control operations of computing device pursuant to the software. The system and operating system, in whole or in part, may be read by processor, buffered within processor, and then executed.

In the context of this document, a “computer-readable medium” may be any means that can store, communicate, propagate, or transport data objects for use by or in connection with the system. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and stored in a computer memory. The system can be embodied in any type of computer-readable medium for use by or in connection with an instruction execution system or apparatus, such as a computer.

For purposes of connecting to other computing devices, computing device is equipped with network communication equipment and circuitry. In a preferred embodiment, the network communication equipment includes a network card such as an Ethernet card, or a wireless connection card. In a preferred network environment, each of the plurality of computing devices on the network is configured to use the Internet protocol suite (TCP/IP) to communicate with one another. It will be understood, however, that a variety of network protocols could also be employed, such as IEEE 802.11 Wi-Fi, address resolution protocol ARP, spanning-tree protocol STP, or fiber-distributed data interface FDDI. It will also be understood that while a preferred embodiment of the invention is for each computing device to have a broadband or wireless connection to the Internet (such as DSL, Cable, Wireless, T-1, T-3, OC3 or satellite, etc.), the principles of the invention are also practicable with a dialup connection through a standard modem or other connection means. Wireless network connections are also contemplated, such as wireless Ethernet, satellite, infrared, radio frequency, Bluetooth, near field communication, and cellular networks. In certain aspects, standalone systems not requiring connectivity to other systems are also contemplated.

Disclosed is a method for rewarding streaming media consumption of a media consumer with a redeemable electronic reward, the method including: (a) providing a database for storing a user account associated with the media consumer; (b) accessing a user identification engine that obtains information from the media consumer, the user identification engine configured for populating the user account of the media consumer with streamed media of the media consumer; (c) monitoring and capturing information related to the amount of streamed media of the media consumer in a predetermined period of time with a data capture program that is in operable communication with the user identification engine relating to the streamed media of the media consumer; (d) analyzing the captured information related to the streamed media of the media consumer to determine if a predetermined threshold of streamed media has been reached by the media consumer; (e) confirming that the predetermined threshold of step (d) has been reached by the media consumer; and (f) rewarding the media consumer with the redeemable electronic reward after step (e) based on the media consumer reaching the predetermined threshold of media consumption by electronically communicating the redeemable electronic reward to the media consumer, wherein: the redeemable electronic reward comprises at least one of a gift card, digital memorabilia, or a combination thereof. In certain aspects, the disclosed method can be utilized for one device (e.g., a peripheral device, gaming console, device dedicated solely for streaming, etc.) or can be utilized by a plurality of these devices. In certain aspects, the redeemable electronic reward may be tied to viewing consumption for one specific device, or the redeemable electronic reward may be tied to aggregated data from viewing consumption of a plurality of devices utilized in the disclosed methods and systems. In certain aspects, the methods and systems can apply to partially viewed and/or completely viewed (and/or listened to) streamed content.

In certain aspects, the methods and systems utilize a peripheral device (e.g., a smartphone, a laptop, a tablet, etc.) of the media consumer and the electronic redeemable reward is communicated to the peripheral device of the media consumer. In certain aspects, the method consists of sequential steps (a)-(f).

In certain aspects, the method further includes associating the streamed media by the media consumer with a single streamed media provider, the streamed media provider including a celebrity, an athlete, a musician, or a combination thereof.

In certain aspects, the media provider rewards the media consumer with digital memorabilia. The digital memorabilia is an electronic autograph, an electronic written message, an electronic video message, or a combination thereof.

In certain aspects, the digital memorabilia includes at least two of the following: (i) an electronic autograph, (ii) an electronic written message, (iii) an electronic video message, or (iv) a combination thereof.

In certain aspects, the digital memorabilia further includes a certificate of authenticity verifying authenticity of the digital memorabilia. For example, the certificate of authentication may be generated by a scoring number associated with a media provider's signature (and/or writing samples), voice recognition, facial recognition, or a combination thereof. The media provider's autograph or electronic written message, for example, must achieve at least a 90% confidence level based on an X,Y array coordinates including a statistical comparison of velocity between coordinates and relative position of points between coordinates and the voice message, video message, or combination thereof, if present, must achieve at least a 90% confidence level based on amplitude and frequency and/or facial recognition when compared to reference samples of the media provider. Facial recognition can be calculated using a two dimensional mapping matrix comparing X,Y array coordinates of the media provider and comparing these values to a control, reference sample. In other aspects, the media provider's electronic signature or the electronic written message must achieve at least a 95% confidence level based on an X,Y array coordinates including a statistical comparison of velocity between coordinates and relative position of points between coordinates and the voice message, video message, or combination thereof, if present, must achieve at least a 95% confidence level based on amplitude and frequency and/or facial recognition when compared to reference samples of the media provider. In additional aspects, the electronic signature and the electronic written message must achieve at least a 99% confidence level based on an X,Y array coordinates including a statistical comparison of velocity between coordinates and relative position of points between coordinates and wherein at least one of the voice message, the video message, or a combination thereof and must achieve at least a 99% confidence level based on amplitude and frequency and/or facial recognition when compared to reference samples of the media provider.

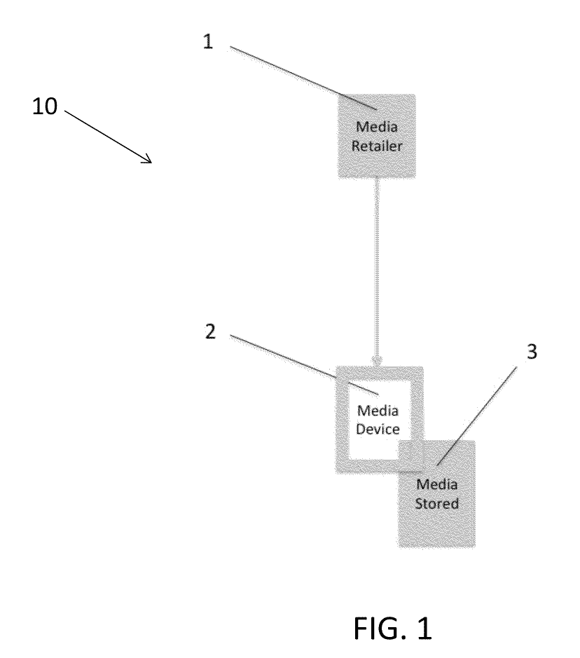

With regard to FIGS. 1-4, the following Figure Legend is provided:

The following reference numerals are used to indicate the parts and environment of the invention on the drawings:
1—Traditional purchasing-based media retail company.
2—A consumer's media device. The device is owned by the consumer and stores the purchased media either locally on the device or in a cloud-based storage system.
3—Digital media (music, movies, tv, video games, etc.) stored on a consumer's device or in a cloud-based system.
114—A streaming service that provides digital media (music, movies, tv, video games, etc.) to a consumer.
115—The digital media is consumed immediately and is not stored locally or in a cloud-based system. In order to be viewed/listened to again, the consumer must reorder the same media a second time.
116—A software application the media consumer places on their player device so consumed streamed media can be counted and captured.
117—Registry component, a database containing an archive of the digital media choices consumed by each consumer.
118—The artist component, where the artist receives info from the database and rewards or incentivizes the consumer with a personalized message and/or reward sent to the consumer's media consumption device.

Consumers initially download or stream digital content to their peripheral device (mobile phone, tablet, or laptop). For example, consumers place their application-enabled peripheral device which is played by an application (including any compatible media player); the application captures real-time data about the media content (e.g. audio) responsive to user inputs. Illustrative user inputs include rewind, replay, mark as favorite, add to playlist, like, unlike star rating or any other input which indicates the user's level of appreciation for the content. The captured programming data is analyzed and matched via a network of servers; and feedback is provided to the content provider (including the creator or artist) based on the captured data. Preferably, the consumer will be rewarded for positive inputs. The consumers may additionally (or alternatively) engage with the system using their personal computer and/or tablet computer if they are interested in having more robust interactions with the system.

To encourage further, more extensive use, users are provided incentives such as downloads, limited content, discounts, loyalty points and the like. Additionally, the system can identify and reward even passive users thereby providing incentives for using the system and consuming the relevant media. Incentives can be tiered. The reward system can be tailored to increase and maintain interactions between consumers and content/media providers, including, but not limited to engaging users with special offers, involving them in polling exercises, and exposing them to additional adjunct content. For instance, the user could get additional rewards in selected instances for listening to a particular track or artist N number of times in a given time period, by reacting to content of the media (i.e. replay, like, etc.), and/or by sharing their consumption via social media (in real-time as well as historically).

Referring to FIG. 1, an exemplary system and method 10 for conventionally purchasing digital media over a network (Internet or other network) that is delivered to a media player and/or storage device 2. A retailer component 1 provides the digital media over a network upon a purchase. The media is delivered to the consumer's media device 2 where the various media files (music, movies, etc.) can be viewed. The delivered media 3 is delivered to and stored on the consumer's media player/storage device or through a cloud-based storage option.

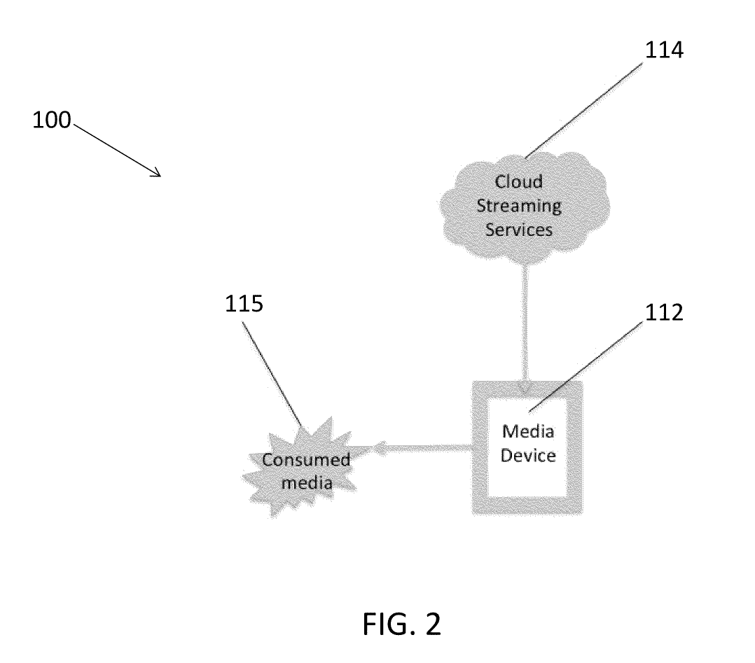

FIG. 2 depicts an exemplary method for streaming media 100 to a peripheral device. Referring to FIG. 2, streaming digital media is delivered to a consumer's device 112 similarly to that depicted in FIG. 1; however, instead of an outright purchase for permanent ownership/storage, the media is simply licensed for temporary consumption 115 and supported either by advertising revenue or a consumer-paid subscription model.

The streaming media provider 114 sends the requested digital media to a consumer's device upon request 112. The consumer listens to, watches, or participates with others in consuming the digital media. But unlike the methods and systems of FIG. 1, the media itself is not saved locally nor archived elsewhere. The media simply disappears upon consumption 115 and is no longer available to the consumer unless requested or broadcast again 115.

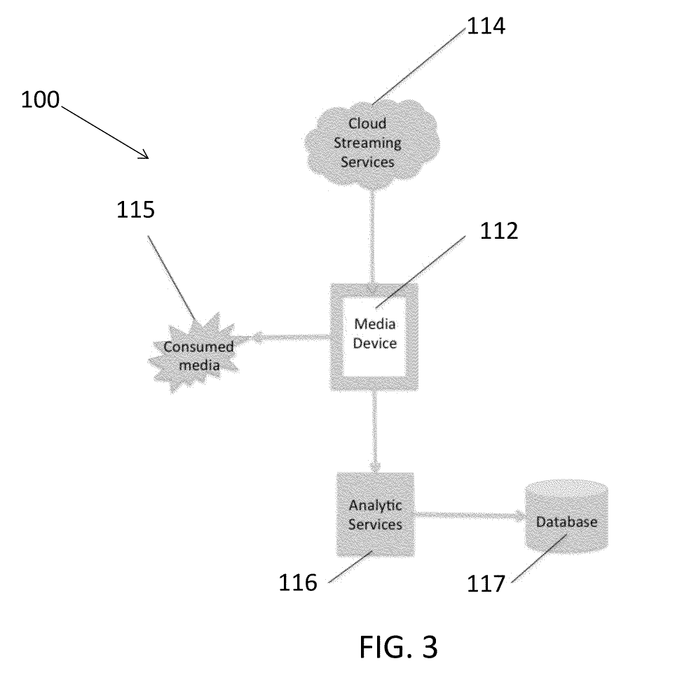

Referring to FIG. 3, the invention provides a means for monitoring the streaming media 114 delivered to the consumer's media player device 112 across multiple service providers by including a software application 116 on the consumer's media device 112 that counts and compiles the number of times a piece of media is consumed on the media device 112. The software 116 transmits the information along with the accompanying metadata to a central database 117 for archiving and analysis.

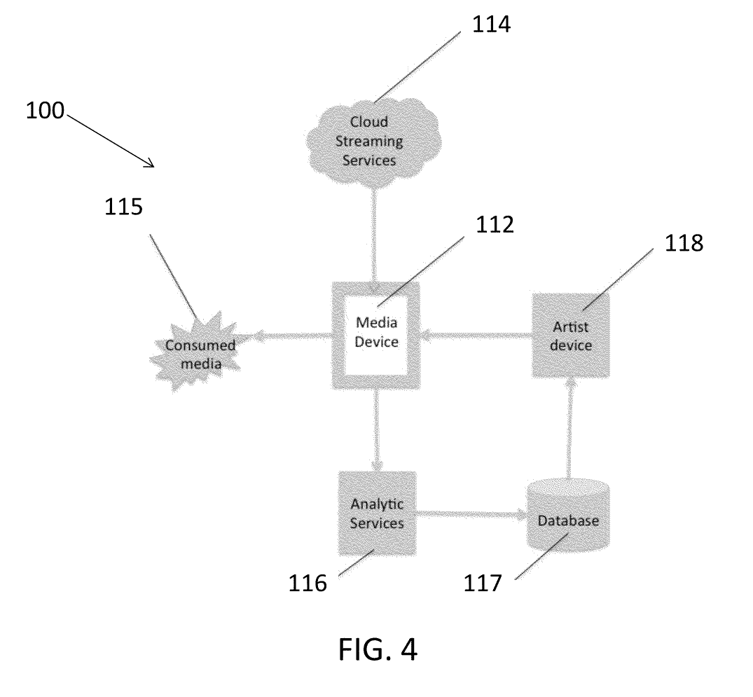

Referring to FIG. 4, the databased information on consumption is analyzed and provided to the media provider (artist). Analyzing information stored in the database 117 the artist can use their own device 118 to personalize additional digital media to send to the consumer's device 112. For example, this personalized digital media may include an autographed photo, video/audio, or an electronic gift card to the consumer's device as a reward or incentive for consuming the artist's work. The personalized media from the artist (including a reward or gift card) can be printed and enjoyed in the physical realm or cashed in during a live event (tickets, back stage passes, meet-n-greets, merchandise, etc.).

Raw data analytics provide an additional potential advantage of the disclosed invention. By compiling aggregated data, the system may allow determination of the most consumed media, identify adjunct content, determine media-clusters, the most watched shows, and the most discussed shows. In combination with secure, private collection of data from the viewers, a nearly endless variety of analytics may be conducted. For instance, the demographic, content viewing and reward selection data may combine to tell the owner of certain content that their 20-30 year old viewers are interested in attending concerts, covers, live versus studio performances, or upcoming appearances. In another example, the data could show a correlation between users who redeemed rewards. The analytic engine may skim the data to provide the ability to content providers (including artists) to provide targeted content and demonstrate fan appreciation.

Also disclosed is a non-transitory computer readable medium embodying a program executable in a computing device for rewarding streaming media consumption of a media consumer with a redeemable electronic reward, the method including: (a) providing a database for storing a user account associated with the media consumer; (b) accessing a user identification engine that obtains information from the media consumer, the user identification engine configured for populating the user account of the media consumer with streamed media of the media consumer; (c) monitoring and capturing information related to the amount of streamed media of the media consumer in a predetermined period of time with a data capture program that is in operable communication with the user identification engine relating to the streamed media of the media consumer; (d) analyzing the captured information related to the streamed media of the media consumer to determine if a predetermined threshold of streamed media has been reached by the media consumer; (e) confirming that the predetermined threshold of step (d) has been reached by the media consumer; and (f) rewarding the media consumer with the redeemable electronic reward after step (e) based on the media consumer reaching the predetermined threshold of media consumption by electronically communicating the redeemable electronic reward to the media consumer, wherein: the redeemable electronic reward includes at least one of a gift card, digital memorabilia, or a combination thereof. In certain aspects, the non-transitory computer readable medium consists of sequential steps (a)-(f).

The foregoing description provides embodiments of the invention by way of example only. It is envisioned that other embodiments may perform similar functions and/or achieve similar results. Any and all such equivalent embodiments and examples are within the scope of the present invention and are intended to be covered by the appended claims.

What is claimed is:

1. A method for rewarding streaming media consumption of a media consumer with a redeemable electronic reward, the method comprising:
(a) providing a database for storing a user account associated with the media consumer;
(b) accessing a user identification engine that obtains information from the media consumer, the user identification engine configured for populating the user account of the media consumer with streamed media of the media consumer;
(c) monitoring and capturing information related to the amount of streamed media of the media consumer in a predetermined period of time with a data capture program that is in operable communication with the user identification engine relating to the streamed media of the media consumer;
(d) analyzing the captured information related to the streamed media of the media consumer to determine if a predetermined threshold of streamed media has been reached by the media consumer;
(e) confirming that the predetermined threshold of step (d) has been reached by the media consumer; and
(f) rewarding the media consumer with the redeemable electronic reward after step (e) based on the media consumer reaching the predetermined threshold of media consumption by electronically communicating the redeemable electronic reward to the media consumer, wherein:
the redeemable electronic reward comprises at least one of a gift card, digital memorabilia, or a combination thereof.

2. The method of claim 1, wherein the method consists of sequential steps (a)-(f).

3. The method of claim 1, further comprising associating the streamed media by the media consumer with a single streamed media provider, the streamed media provider including a celebrity, an athlete, a musician, or a combination thereof.

4. The method of claim 3, wherein the media provider rewards the media consumer with digital memorabilia.

5. The method of claim 4, wherein the digital memorabilia is an electronic autograph, an electronic written message, an electronic video message, or a combination thereof.

6. The method of claim 4, wherein the digital memorabilia comprises at least two of an electronic autograph, an electronic written message, an electronic video message, or a combination thereof.

7. The method of claim 5, further comprising a certificate of authenticity verifying authenticity of the digital memorabilia.

8. The method of claim 6, further comprising a certificate of authenticity verifying authenticity of the digital memorabilia.

9. A non-transitory computer readable medium embodying a program executable in a computing device for rewarding streaming media consumption of a media consumer with a redeemable electronic reward, the method comprising:
(a) providing a database for storing a user account associated with the media consumer;
(b) accessing a user identification engine that obtains information from the media consumer, the user identification engine configured for populating the user account of the media consumer with streamed media of the media consumer;
(c) monitoring and capturing information related to the amount of streamed media of the media consumer in a predetermined period of time with a data capture program that is in operable communication with the user identification engine relating to the streamed media of the media consumer;
(d) analyzing the captured information related to the streamed media of the media consumer to determine if a predetermined threshold of streamed media has been reached by the media consumer;
(e) confirming that the predetermined threshold of step (d) has been reached by the media consumer; and
(f) rewarding the media consumer with the redeemable electronic reward after step (e) based on the media consumer reaching the predetermined threshold of media consumption by electronically communicating the redeemable electronic reward to the media consumer, wherein:
the redeemable electronic reward comprises at least one of a gift card, digital memorabilia, or a combination thereof.

10. The non-transitory computer readable medium of claim 9, wherein the non-transitory computer readable medium consists of sequential steps (a)-(f).
